(19) United States
(12) Patent Application Publication
(10) Pub. No.: US 2019/0195072 A1
(43) Pub. Date: Jun. 27, 2019

(54) TURBINE ROTOR DISC HAVING MULTIPLE RIMS

(71) Applicant: Rolls-Royce North American Technologies Inc., Indianapolis, IN (US)

(72) Inventors: Douglas D. Dierksmeier, Franklin, IN (US); Ryan C. Humes, Indianapolis, IN (US)

(73) Assignee: Rolls-Royce North American Technologies Inc., Indianapolis, IN (US)

(21) Appl. No.: 15/852,722

(22) Filed: Dec. 22, 2017

(51) Int. Cl. F01D 5/06; F01D 5/30

(52) U.S. Cl. CPC F01D 5/06; F01D 5/3007; F05D 2220/32; F05D 2260/30; F05D 2230/13; F05D 2230/25; F05D 2230/10

(57) ABSTRACT

A disc for use in a turbine rotor is provided including a hub, a plurality of webs extending outwardly from the hub, and a plurality of rims. Each of the plurality of webs are separate from each other by a gap. Each rim is positioned at an outward end of one of the webs. Each rim is configured to receive a respective set of turbine blade.

### TECHNICAL FIELD

This disclosure relates to rotors for gas turbine engines, and, in particular to discs within a turbine section of a rotor.

### BACKGROUND

Turbine sections of gas turbine engines typically include rotors having discs that connect to turbine blades. Typically, each rotor has a disc for each stage of turbine blades in the turbine section.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a cross-sectional view of an example of a gas turbine engine;

FIG. 2 illustrates a front plan view of a first example of a disc;

FIG. 3 illustrates a partial cross-sectional side view of a second example of the disc;

FIG. 4 illustrates a partial cross-sectional side view of a third example of the disc;

FIG. 5 illustrates a partial cross-sectional side view of a fourth example of the disc;

FIG. 6 illustrates a partial cross-sectional side view of a fifth example of the disc;

FIG. 7 illustrates a side plan view of an example of the rim; and

FIG. 8 illustrates a flow diagram of an example of a method of manufacturing a disc.

### DETAILED DESCRIPTION

Having a disc for each stage of turbine blades may increase the complexity of the turbine section, thus increasing the cost of the turbine engine and increasing the number of parts prone to failure within the engine. Additionally, having a disc for each stage of the turbine blades requires additional machining work as each disc must be machined. It is desirable that the rotor be less expensive, require fewer parts, and require less machining by having fewer discs.

The following description is merely exemplary in nature and is not intended to limit the present disclosure, application, or uses.

By way of an introductory example, a disc for use in a turbine rotor is provided, including a hub and a plurality of webs extending outwardly from the hub. Each of the plurality of webs are separate from each other by a gap. Each of the webs include a rim positioned at the outward end of the web, wherein the rims are each configured to receive a turbine blade.

One interesting feature of the systems and methods described below may be that the single disc may be cheaper to produce than a collection of traditional discs holding a similar number of turbine blades. Alternatively, or in addition, an interesting feature of the systems and methods described below may be that a rotor incorporating the disc may have fewer components than in traditional rotors, which may increase the durability and decrease the cost of the rotor.

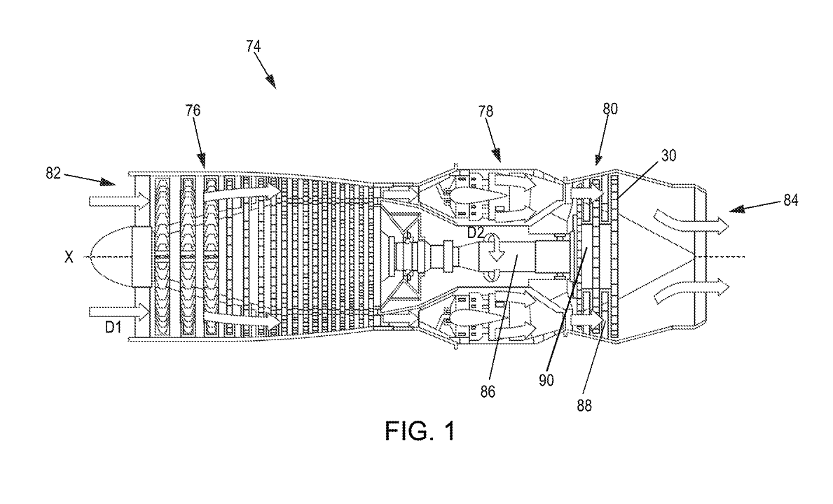

FIG. 1 is a cross-sectional view of a gas turbine engine 74 for propulsion of, for example, an aircraft. Alternatively or in addition, the gas turbine engine 74 may be used to drive a propeller in aquatic applications, or to drive a generator in energy applications. The gas turbine engine 74 may include an intake section 82, a compressor section 76, a combustion section 78, a turbine section 80, and an exhaust section 84. During operation of the gas turbine engine 74, fluid received from the intake section 82, such as air, travels along the direction D1 and may be compressed within the compressor section 76. The compressed fluid may then be mixed with fuel and the mixture may be burned in the combustion section 78. The combustion section 78 may include any suitable fuel injection and combustion mechanisms. The hot, high pressure fluid may then pass through the turbine section 80 to extract energy from the fluid and cause a rotor 90 within the turbine section 80 to rotate, which in turn drives the a shaft 86 which drives the compressor section 76. Discharge fluid may exit the exhaust section 84.

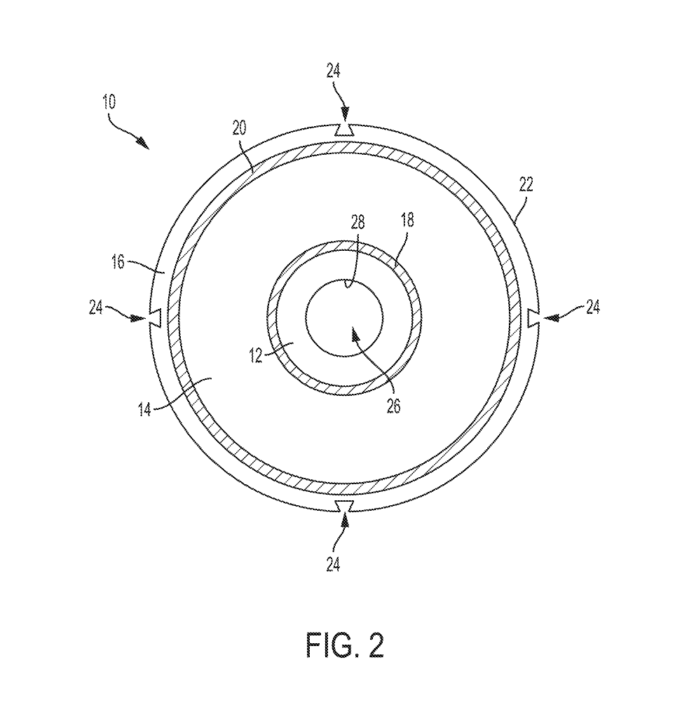

As noted above, the hot, high pressure fluid passes through the turbine section 80 during operation of the gas turbine engine 74. As the fluid flows through the turbine section 80, the fluid passes between alternating turbine blades 30 and vanes 88 causing the rotor 90 to rotate. The rotor 90 may turn a shaft 86 in a rotational direction D2, for example. The turbine blades 30 may rotate around an axis of rotation, which may correspond to a centerline X of the rotor 90 in some examples. The centerline X may be a longitudinal axis which extends across the entire length of the rotor 90, along the axis of rotation. The vanes 88 may remain stationary relative to the turbine blades 30 while the rotor 90 is rotating. The rotor 90 may be coupled to the turbine blades 30 by a disc (10 in FIG. 2) which may extend outwardly from the rotor 90.

FIG. 2 illustrates a front plan view of a first example of the disc 10 including a hub 12, a web 14, and a rim 16. The disc 10 may be any component which couples to the rotor 90 and is configured to receive and rotate a set of the turbine blades 30. Examples of the disc 10 may include a cone, a cylinder, or any shape having radial symmetry about the centerline X of the rotor 90. The disc 10 may be made from any material capable of withstanding the radial forces and thermal stresses of operating in the turbine section 80, such as titanium or stainless steel. All components of the disc 10, including the hub 12, the webs 14, and the rim 16 may be made from a single forging and machining process.

The hub 12 may be the most inward portion of the disc 10 and may be any portion of the disc configured to be coupled to the rotor 90. Examples of the hub 12 may include a cone, a cylinder, or any other radially symmetric shape. The hub 12 may be made from the same materials as any other portion of the disc 10. The hub 12 may include an inner surface 28 defining a lumen 26 of the disc 10. The rotor 90 may pass through the lumen 26 and be coupled to the hub 12 by the inner surface 28.

The web 14 may be any portion of the disc 10 which extends outwardly from the hub 12. Examples of the web 14 may include a cone, a cylinder, or any other radially symmetric shape. In some examples, the web 14 may be a solid plate that connects the hub 12 to the rim 16. The web 14 may be made from the same materials as any other portion of the disc 10. In embodiments wherein the hub 12 and the web 14 have different thicknesses, a hub transition 18 may exist between an outward end of the hub 12 and an inward end of the web 14 which smoothly transitions outwardly to match the thickness of the web 14.

The rim 16 may be any portion of the disc 10 which forms the outward portion of the disc 10 and extends outwardly from the web 14. Examples of the rim 16 may include a cone, a cylinder, or any other radially symmetric shape. The rim 16 may be made from the same materials as any other portion of the disc 10. In embodiments wherein the web 14 and the rim 16 have different thicknesses, a rim transition 20 may exist between an outward end of the web 14 and an inward end of the rim 16 which smoothly transitions outwardly to the thickness of the rim 16. The rim 16 may include an outer surface 22 configured to receive turbine blades 30 within grooves 24 formed in the outer surface 22. The groove 24 may be any feature which may receive and secure a portion of the turbine blade 30. Examples of the groove 24 may include a wedge-shaped slot, a circular trench, or a complex depression including sets of interacting teeth.

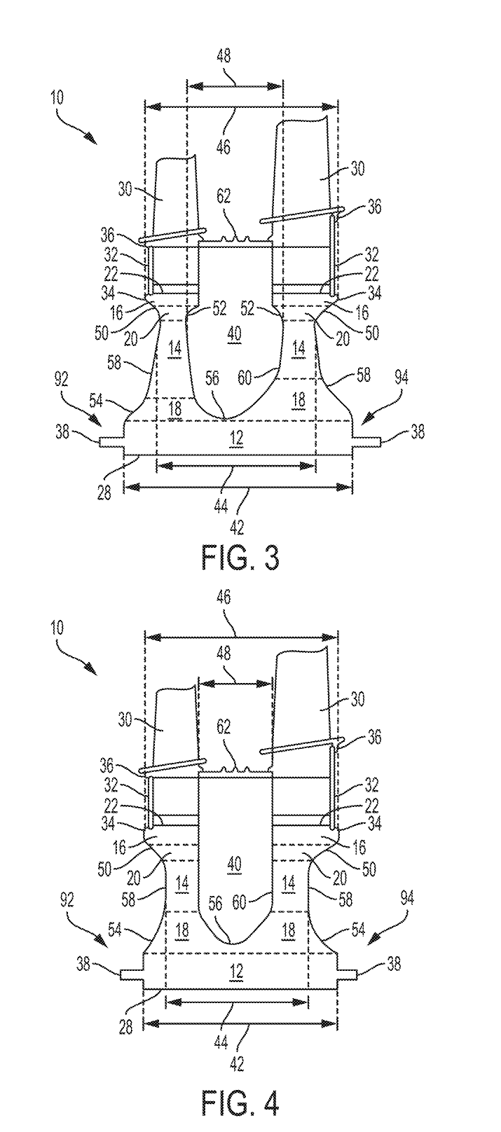

FIG. 3 illustrates a partial cross-sectional side view of a second example of the disc 10 including the hub 12, a plurality of webs 14, a plurality of rims 16, where each of the rims 16 are coupled to a corresponding set of the turbine blades 30. Each of the webs 14, the rims 16, and the sets of the turbine blades 30 may extend radially outwardly from a unitary hub 12 to form a respective stage of the turbine blades 30 within the turbine section 80 of the gas turbine engine 74. The unitary hub 12 shown in FIG. 3 may include as few as two webs 14, or may extend the entire length of the turbine section 80, such that every web 14 in the turbine section 80 extends from the single unitary hub 12. In the embodiment shown in FIG. 3, the webs 14 are axially spaced apart from one another to form a gap 40 between each of the webs 14. The gap 40 may be any space which separates the webs 14 and rims 16 sufficiently that a vane 88 may be arranged between the turbine blades 30 extending from each of the rims 16. The webs 14 and the rims 16 may also have an internal surface 60 which defines the gap 40. The internal surfaces 60 of the webs 14 may be meet at a trough 56 at the most inward point of the gap 40.

Each of the webs 14 and rims 16 may also include an external surface 58 which is on an opposing side of the web 14 as the internal surface 60 of the web 14. The external surface 58 may extend from the inner surface 28 of the hub 12 to the outer surface 22 of the rim 16. The external surfaces 58 may be located at the first end 92 and the second end 94 of the disc 10. Therefore, in some embodiments, such as when more than two webs 14 extending outwardly from the hub 12, only the webs 14 at the first end 92 and second end 94 of the disc 10 may have external surfaces 58. In such embodiments, the webs 14 located internally from the first end 92 and second end 94 of the disc 10 may have opposing internal surfaces 60 defining gaps 40 between webs 14 on either side of the web 14.

The disc 10 may extend axially from a first end 92 to a second end 94. As shown in FIG. 3, the disc 10 may include connectors 38 protruding from the hub 12 in some examples. The connectors 38 may be used to connect the disc 10 to additional discs 10 located upstream or downstream in the turbine section 80. The connectors 38 may be formed as part of the hub 12, or may be brazed or welded to the hub 12. In alternative examples, the connectors 38 may not be needed to connect the discs 10 and may not be included in the disc 10.

The disc 10 may also include retaining plates 32 configured to secure the turbine blades 30 to the rims 16. The rims 16 may include an upward-facing notch 34 or other device to receive and secure the retaining plate 32 against an opposing downward-facing notch 36 in the turbine blade 30. Once secured, the retaining plate 32 may prevent the turbine blade 30 from sliding axially out of the grooves 24 within the outer surface 22 of the rim 16. The retaining plates 32 may be located on both sides of each turbine blade 30, or just on one side. In some embodiments, the retaining plates 32 may not be utilized to secure the position of the turbine blades 30.

The disc 10 may also include a spacer 62 which may span the gap 40 between the turbine blades 30 coupled to the rims 16. Examples of the spacer 62 may include a ring, a cylinder, or a tube. The spacer 62 may be configured to contact the vanes 88 within the turbine section 80.

The hub 12 may provide the primary structural support to the disc 10. The web 14 and rim 16 may be less critical to the structure of the disc 10 and provide unnecessary weight to the disc 10. Therefore, the hub 12 may have a thickness 42 which is greater than the thickness of any web 14 or rim 16 extending radially outwardly from the hub 12. In some embodiments, as shown in FIG. 3, the thickness 42 of the hub 12 in an axial direction may be greater than the sum of all of the thickness of the webs 14 extending from the hub 12. Similarly, in some embodiments, as shown in FIG. 3, the thickness 42 of the hub 12 in the axial direction may be greater than the sum of all of the thickness of the rims 16 extending radially from the hub 12. In some examples, such configurations may maximize structural support for the disc 10 while minimizing the weight of the disc 10. Additionally, as shown in FIG. 3, the rim 16 may have a greater thickness in the axial direction than the web 14 in order to accommodate and provide structural support to the turbine blades 30 that are coupled to the rim 16.

In some embodiments, the thickness of the web 14 in the axial direction may decrease as the web 14 extends outwardly. In such embodiments, a width 48 of the gap 40 in the axial direction may increase as the gap 40 extends radially outwardly. The width 48 of the gap 40 in the axial direction may decrease between the web 14 and the rim 16, as the rim transition 20 may cause the internal surface 60 to have a flare 52 to accommodate the larger thickness of the rim 16 as compared to the web 14.

As shown in FIG. 3, in some embodiments, the thickness 42 of the hub 12 may be greater than a total rim thickness 46 of the disc 10, wherein the total rim thickness 46 extending axially from the external surface 58 of the rim 16 located at the first end 92 of the disc 10 to the external surface 58 of the rim 16 located at the second end 94 of the disc 10. Also shown in FIG. 3, in some embodiments, the total rim thickness 46 of the disc 10 may be greater than a total web thickness 44 of the disc 10, wherein the total web thickness 44 extending from the external surface 58 inward from the rim 16 located at the first end 92 of the disc 10 to the external surface 58 inward from the rim 16 located at the second end 94 of the disc 10. The total rim thickness 46 may increase between the web 14 and the rim 16, as the rim transition 20 may cause the external surface 58 to have a flare 50 to accommodate the larger thickness of the rim 16.

FIG. 4 illustrates a partial cross-sectional side view of a third example of the disc 10 including the hub 12, a plurality of webs 14, a plurality of rims 16, and a plurality of turbine blades 30. As shown in FIG. 4, in some embodiments, the width 48 of the gap 40 may be substantially uniform extending from an inward end of the web 14 to the outer surface 22 of the rim 16. Additionally, as shown in FIG. 4, in some embodiments, the thickness 42 of the hub 12 may be substantially equal to the total rim thickness 46 of the disc 10. In such embodiments, the stress on the disc 10 may be directed outward in a linear fashion to minimize any warping or bending that may occur during operation of the rotor 90.

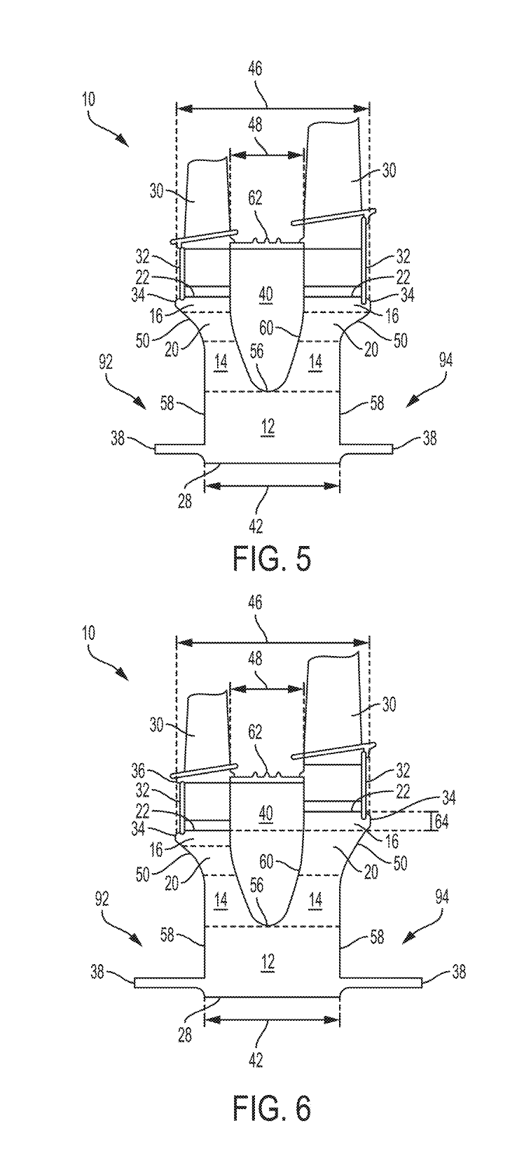

FIG. 5 illustrates a partial cross-sectional side view of a fourth example of the disc 10 including the hub 12, a plurality of webs 14, a plurality of rims 16, and a plurality of turbine blades 30. As shown in FIG. 5, in some embodiments, the thickness 42 of the hub 12 may be less than the total rim thickness 46 of the disc 10. In such a configuration, the external surfaces 58 of the webs 14 and rims 16 may be angled or flared toward the first end 92 and second end 94 of the disc 10. Such a configuration may put more bending stress on the webs 14 during operation of the rotor 90, but the reduced thickness 42 of the hub 12 may decrease the weight of the disc 10.

In some examples, as shown in FIGS. 3-5, the outer surfaces 22 of the rims 16, which face radially outward may be substantially aligned with one another, such that the outer surfaces 22 are equidistant to the centerline X of the rotor 90. Such a configuration may reduce the difficulty and cost of machining the disc 10.

FIG. 6 illustrates a partial cross-sectional side view of a fifth example of the disc 10 including the hub 12, the webs 14, the rims 16, and the turbine blades 30. As shown in FIG. 6, in some embodiments, the outer surfaces 22 of the rims 16 may have an offset 64, such that one outer surface 22 is inwardly closer to the centerline X of the rotor 90 than another outer surface 22. Such a configuration may accommodate the layout of some turbine sections 80. For example, some turbine sections 80 are arranged such that discs 10 must extend outwardly at increasingly greater distances the further the turbine section 80 proceeds downstream. In such a configuration, the embodiment of the disc 10 illustrated in FIG. 6 may reduce the number of parts needed within the turbine section 80 and simplify the design of the rotor 90, which may enhance the reliability of the rotor 90 and decrease the cost of the rotor 90.

As shown in FIG. 6, the rim 16 which extends furthest from the centerline X of the rotor 90 may have the largest diameter and therefore, the largest circumference. In some embodiments, the portion of the turbine blades 30 coupled to the larger rim 16 may be equal to the portion of the turbine blades 30 coupled to the smaller rim 16. However, in such a configuration, the distribution of turbine blades 30 coupled to the largest rim 16 would be less dense than the distribution of turbine blades 30 coupled to the smaller rim 16. Alternatively, the portion of the turbine blades 30 coupled to the larger rim 16 may be greater than the portion of the turbine blades 30 coupled to the smaller rim 16. In such a configuration, the distribution of turbine blades 30 coupled to the largest rim 16 may have equivalent or greater density when compared to the distribution of turbine blades 30 coupled to the smaller rim 16. The number of turbine blades 30 on a rim 16 may vary from between 20 and 200.

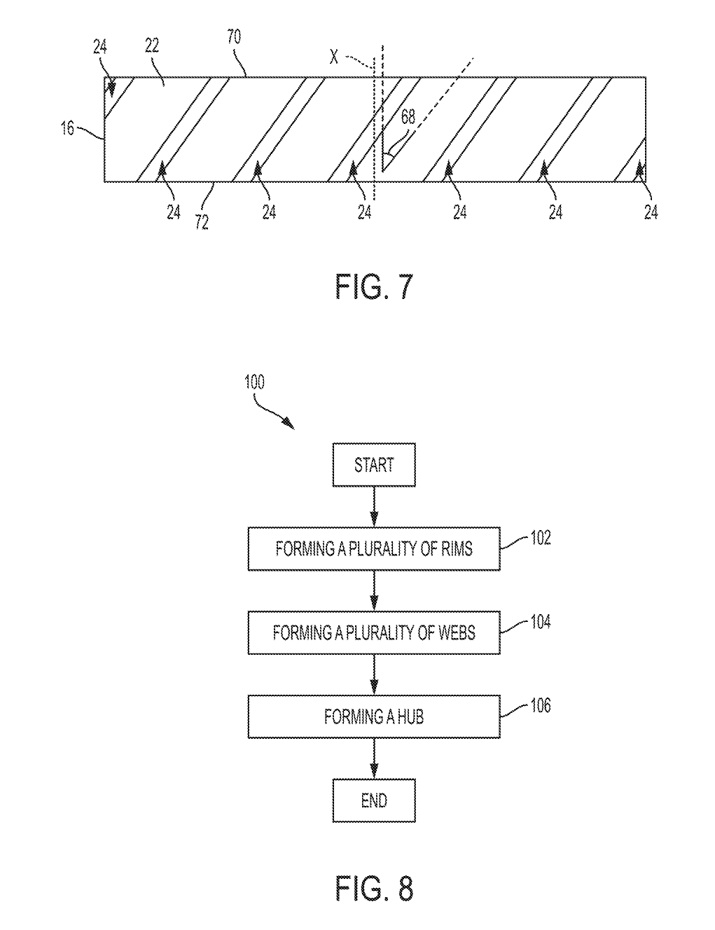

FIG. 7 illustrates a side plan view of an example of the rim 16. The outer surface 22 of the rim 16 includes the grooves 24 distributed about the circumference of the rim 16 and configured to receive turbine blades 30. The grooves 24 may extend across the entire thickness of the rim 16, from a first end 70 of the rim 16 to a second end 72 of the rim 16. In some embodiments, the grooves 24 may have an angular offset 68 with respect to the centerline X of the rotor 90 to accommodate an offset aspect of the turbine blades 30 within turbine section 80. Additionally, the angular offset 68 of the grooves 24 may vary as the rims 16 are positioned upstream or downstream within the turbine section 80.

FIG. 8 illustrates a flow diagram of an example of a method of manufacturing the disc 10 for use in the rotor 90 of the gas turbine engine 74 (100). The steps may include additional, different, or fewer operations than illustrated in FIG. 8. The steps may be executed in a different order than illustrated in FIG. 8.

A plurality of rims 16 are formed (102) from the material comprising the disc 10. A plurality of webs 14 are also formed (104), wherein each of the webs 14 are coupled to one of the rims 16. A gap 40 is formed between each of the webs 14 and between each of the rims 16. A hub 12 Is also formed (106) wherein each of the webs 14 is coupled to the hub 12.

In some embodiments of the method (100), the disc 10 including the rims 16, webs 14, and unitary hub 12 may be formed from a single-forged workpiece or single-forged material. The single-forged workpiece may be any object comprising a forged uniform metallic material, such as stainless steel or titanium. Examples of the single-forged workpiece may include a block, a cylinder, or an irregular shaped chunk. The single-forged workpiece may be formed into the disc 10 by a number of methods such as milling, wherein the single-forged workpiece may be machined by a rotating tool, or by lathe turning, wherein the rotating single-forged workpiece may be machined by a tool. The outer surface of single-forged material may be initially smoothed, removing any surface irregularities from forging. In some embodiments, the disc 10 is formed from the most outward portions and proceeding inwardly. For example, the outwardly most portions of the disc 10, the rims 16 may be formed before the webs 14. Similarly the webs 14 may be formed before forming the unitary hub 12 of the disc 10. The lumen 26 of the disc may be formed initially to accommodate lathe turning machining or may be formed at any other point in the machining process.

The method (100) may further include forming the grooves 24 in the outer surface 22 of the rim 16. The grooves 24 may be formed using a variety of techniques such as milling or electrical discharge machining. One method of forming the grooves may include linearly broaching the grooves 24 using a shaped broach bar. Where the angular offset 68 of the grooves 24 is low and the offset 64 between the outer surfaces 22 of the plurality of rims 16 is low, a single broach bar may be used through the plurality of rims 16 in a single operation, reducing the complexity, difficulty, and cost of the machining process.

Each component may include additional, different, or fewer components. For example, the disc 10 may include more than two webs 14 extending outwardly from the unitary hub 12. Additionally, in some embodiments, the webs 14 may not be present. Instead, a plurality of rims 16 would extend directly outward from the unitary hub 12, forming the gap 40 and receiving the blades 30.

The method (100) may be implemented with additional, different, or fewer components. For example, in some embodiments of the method (100) the step of forming the plurality of webs (104) may be omitted. This may be particularly relevant in embodiments wherein a plurality of rims 16 extend directly outward from the unitary hub 12 eliminating the plurality of webs 14.

The logic illustrated in the flow diagrams may include additional, different, or fewer operations than illustrated. The operations illustrated may be performed in an order different than illustrated.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:

1. A disc for use in a turbine rotor, comprising:

a hub; and

a plurality of webs extending radially outwardly from the hub, wherein each of the plurality of webs is separated from another of the webs by a gap; and

a plurality of rims, wherein each rim is positioned at an outward end of one of the webs, wherein each rim is configured to receive a respective set of turbine blades.

2. The disc of claim 1, wherein the webs include a first web and a second web, and wherein the first web extends radially outward at a first end of the disc and the second web extends radially outward at a second end of the disc, each of the first web and the second web comprising an internal surface and an external surface, wherein the internal surface of the first web and the internal surface of the second web define the gap between the first web and the second web.
3. The disc of claim 2, wherein the disc further comprises a total rim thickness extending between the first end of the disc at the rim of the first web and the second end of the disc at the rim of the second web and a hub thickness at the hub of the disc which is less than the total rim thickness.
4. The disc of claim 2, wherein the external surface of the first web at the rim and the external surface of the second web at the rim are flared such that a total rim thickness extending between the first end of the disc at the rim of the first web and the second end of the disc at the rim of the second web is greater than a total web thickness between the external surface of the first web inward from the rim and the external surface of the second web inward from the rim.
5. The disc of claim 2, wherein a width of the gap between the internal surface and the first web and the internal surface of the second web increases as the gap extends outwardly.
6. The disc of claim 2, wherein a width of the gap is substantially uniform from an inward end of each of the first web and second web extending outwardly to the outward ends of each of the first web and the second web.
7. A rotor of a gas turbine engine comprising,

a disc comprising a unitary hub, a plurality of webs extending outwardly from the unitary hub, and a plurality of rims, wherein each of the plurality of webs is spaced apart from each other, and wherein each of the plurality of rims is positioned at an outward end of each of the webs; and

a plurality of turbine blades, wherein each turbine blade is coupled to one of the rims.

8. The rotor of claim 7, wherein the disc extends from a first end of a turbine section of the gas turbine engine to a second end of the turbine section of the gas turbine engine.
9. The rotor of claim 7, wherein each rim comprises an outer surface, wherein a first outer surface of a first rim is inwardly closer to a center of the disc than a second outer surface of a second rim.
10. The rotor of claim 9, wherein a first portion of the plurality turbine blades coupled to the first rim is less than a second portion of the turbine blades coupled to the second rim.
11. The rotor of claim 9, wherein the disc comprises a longitudinal axis extending through the center of the disc, wherein the plurality of turbine blades are coupled to the first rim and the second rim by a plurality of grooves formed in the outer surfaces of each of the first rim and the second rim, and wherein the plurality of grooves on the outer surface of the first rim are angularly offset from the longitudinal axis of the disc at a first angle and the plurality of grooves on the outer surface of the second rim are angularly offset from the longitudinal axis of the disc at a second angle which is different from the first angle.
12. A method of manufacturing a disc for use in a rotor of a turbine engine, comprising:

forming a plurality of rims;

forming a plurality of webs, wherein each of the plurality of webs is coupled to one of the plurality of rims, and wherein a gap is formed between each of the plurality of webs and each of the plurality of rims; and

forming a hub, wherein each of the plurality of webs is coupled to the hub.

13. The method of claim 12, further comprising forming a plurality of grooves into each of the rims, wherein each of the grooves is shaped to receive a turbine blade.
14. The method of claim 13, wherein the plurality of grooves are formed by linear broaching.
15. The method of claim 14, further comprising broaching a groove in a first rim of the plurality of rims and broaching a groove in a second rim of the plurality of rims in a single operation using a broach bar configured to extend across the first rim and the second rim.
16. The method of claim 13, wherein the plurality of grooves are formed by milling.
17. The method of claim 13, wherein the plurality of grooves are formed by electrical discharge machining.
18. The method of claim 12, wherein the plurality of rims, the plurality of webs, and the hub are formed from a single-forged material.
19. The method of claim 18, wherein the plurality of rims, plurality of webs, and the hub are formed from lathe turning of the single-forged material.
20. The method of claim 18, wherein the plurality of rims, plurality of webs, and the hub are formed from milling of the single-forged material.

What is claimed is:

1. A disc for use in a turbine rotor, comprising:
a hub; and
a plurality of webs extending radially outwardly from the hub, wherein each of the plurality of webs is separated from another of the webs by a gap; and
a plurality of rims, wherein each rim is positioned at an outward end of one of the webs, wherein each rim is configured to receive a respective set of turbine blades.

2. The disc of claim 1, wherein the webs include a first web and a second web, and wherein the first web extends radially outward at a first end of the disc and the second web extends radially outward at a second end of the disc, each of the first web and the second web comprising an internal surface and an external surface, wherein the internal surface of the first web and the internal surface of the second web define the gap between the first web and the second web.

3. The disc of claim 2, wherein the disc further comprises a total rim thickness extending between the first end of the disc at the rim of the first web and the second end of the disc at the rim of the second web and a hub thickness at the hub of the disc which is less than the total rim thickness.

4. The disc of claim 2, wherein the external surface of the first web at the rim and the external surface of the second web at the rim are flared such that a total rim thickness extending between the first end of the disc at the rim of the first web and the second end of the disc at the rim of the second web is greater than a total web thickness between the external surface of the first web inward from the rim and the external surface of the second web inward from the rim.

5. The disc of claim 2, wherein a width of the gap between the internal surface and the first web and the internal surface of the second web increases as the gap extends outwardly.

6. The disc of claim 2, wherein a width of the gap is substantially uniform from an inward end of each of the first web and second web extending outwardly to the outward ends of each of the first web and the second web.

7. A rotor of a gas turbine engine comprising,
a disc comprising a unitary hub, a plurality of webs extending outwardly from the unitary hub, and a plurality of rims, wherein each of the plurality of webs is spaced apart from each other, and wherein each of the plurality of rims is positioned at an outward end of each of the webs; and
a plurality of turbine blades, wherein each turbine blade is coupled to one of the rims.

8. The rotor of claim 7, wherein the disc extends from a first end of a turbine section of the gas turbine engine to a second end of the turbine section of the gas turbine engine.

9. The rotor of claim 7, wherein each rim comprises an outer surface, wherein a first outer surface of a first rim is inwardly closer to a center of the disc than a second outer surface of a second rim.

10. The rotor of claim 9, wherein a first portion of the plurality turbine blades coupled to the first rim is less than a second portion of the turbine blades coupled to the second rim.

11. The rotor of claim 9, wherein the disc comprises a longitudinal axis extending through the center of the disc, wherein the plurality of turbine blades are coupled to the first rim and the second rim by a plurality of grooves formed in the outer surfaces of each of the first rim and the second rim, and wherein the plurality of grooves on the outer surface of the first rim are angularly offset from the longitudinal axis of the disc at a first angle and the plurality of grooves on the outer surface of the second rim are angularly offset from the longitudinal axis of the disc at a second angle which is different from the first angle.

12. A method of manufacturing a disc for use in a rotor of a turbine engine, comprising:
forming a plurality of rims;
forming a plurality of webs, wherein each of the plurality of webs is coupled to one of the plurality of rims, and wherein a gap is formed between each of the plurality of webs and each of the plurality of rims; and
forming a hub, wherein each of the plurality of webs is coupled to the hub.

13. The method of claim 12, further comprising forming a plurality of grooves into each of the rims, wherein each of the grooves is shaped to receive a turbine blade.

14. The method of claim 13, wherein the plurality of grooves are formed by linear broaching.

15. The method of claim 14, further comprising broaching a groove in a first rim of the plurality of rims and broaching a groove in a second rim of the plurality of rims in a single operation using a broach bar configured to extend across the first rim and the second rim.

16. The method of claim 13, wherein the plurality of grooves are formed by milling.

17. The method of claim 13, wherein the plurality of grooves are formed by electrical discharge machining.

18. The method of claim 12, wherein the plurality of rims, the plurality of webs, and the hub are formed from a single-forged material.

19. The method of claim 18, wherein the plurality of rims, plurality of webs, and the hub are formed from lathe turning of the single-forged material.

20. The method of claim 18, wherein the plurality of rims, plurality of webs, and the hub are formed from milling of the single-forged material.
